(19) United States
(12) Patent Application Publication
(10) Pub. No.: US 2021/0098206 A1
(43) Pub. Date: Apr. 1, 2021

(54) SAFETY LOCKOUT DEVICE FOR ELECTRICAL SWITCH

(71) Applicant: TAGOUT SAFTEY PRODUCTS LLC, Gresham, OR (US)

(72) Inventors: Todd Thom, Gresham, OR (US); Orville Flowers, Happy Valley, OR (US)

(21) Appl. No.: 17/034,907

(22) Filed: Sep. 28, 2020

Related U.S. Application Data
(60) Provisional application No. 62/907,011, filed on Sep. 27, 2019.

(51) Int. Cl. H01H 9/20; H01H 9/02

(52) U.S. Cl. CPC H01H 9/20; H01H 9/02

(57) ABSTRACT

A safety lockout device can include a main body, a receiving portion of the main body configured to receive a portion of an arm of an electrical switch, and a locking portion of the main body configured to be inserted into a receiving portions of the electrical switch.

### CROSS REFERENCE TO RELATED APPLICATION

This application claims priority to and the benefit of U.S. Provisional Application No. 62/907,011 filed Sep. 27, 2019, which is incorporated herein by reference in its entirety.

### BACKGROUND

The terms lockout and tagout, as used herein, generally refer to certain practices and procedures that have been designed over the years to safeguard people from either or both of the unexpected energization or startup of machinery and equipment and the release of hazardous energy during service or maintenance activities. During a typical lockout/tagout procedure, a designated individual will turn off and disconnect all of the pertinent machinery and/or equipment from the corresponding energy source or sources before performing any service or maintenance thereon.

Also, designated individuals will generally lock and/or tag the energy-isolating devices during a lockout/tagout in order to prevent the release of harmful hazardous energy. Such individuals may also take steps to verify that the potentially harmful energy has indeed been isolated and that the environment is thus safe. It is imperative that a lockout/tagout minimizes or eliminates any potential release of hazardous energy or stored energy as well as a reaccumulation of energy or stored energy to a hazardous level.

Certain conventional techniques for performing a lockout/tagout generally include positioning a device in an electrical switch well. However, such devices do not maintain a fixed position for a blade switch among various other disadvantages.

### TECHNICAL FIELD

The disclosed technology generally pertains to electrical switches such as test switches and, more particularly, to safety lockout devices for electrical switches.

### SUMMARY

Implementations of the disclosed technology are generally directed to various embodiments of a safety lockout device that may be configured to be used in connection with electrical test switches during a lockout/tagout procedure, for example.

### BRIEF DESCRIPTION OF THE DRAWINGS

FIG. 1 is a first front perspective view of a first embodiment of a safety lockout device to be used in connection with an electrical switch in accordance with certain implementations of the disclosed technology.

FIG. 2 is a second front perspective view of the first embodiment of a safety lockout device to be used in connection with an electrical switch in accordance with certain implementations of the disclosed technology.

FIG. 3 is a first back perspective view of the first embodiment of a safety lockout device to be used in connection with an electrical switch in accordance with certain implementations of the disclosed technology.

FIG. 4 is a side elevation view of the first embodiment of a safety lockout device to be used in connection with an electrical switch in accordance with certain implementations of the disclosed technology.

FIG. 5 is a front plan view of the first embodiment of a safety lockout device to be used in connection with an electrical switch in accordance with certain implementations of the disclosed technology.

FIG. 6 is a back plan view of the first embodiment of a safety lockout device to be used in connection with an electrical switch in accordance with certain implementations of the disclosed technology.

FIG. 7 is a top side elevation view of the first embodiment of a safety lockout device to be used in connection with an electrical switch in accordance with certain implementations of the disclosed technology.

FIG. 8 is a bottom side elevation view of the first embodiment of a safety lockout device to be used in connection with an electrical switch in accordance with certain implementations of the disclosed technology.

FIG. 9 is a front perspective view of a second embodiment of a safety lockout device to be used in connection with an electrical switch in accordance with certain implementations of the disclosed technology.

FIG. 10 is a first front perspective view of a third embodiment of a safety lockout device for an electrical switch in accordance with certain implementations of the disclosed technology.

FIG. 11 is a second front perspective view of the third embodiment of a safety lockout device to be used in connection with an electrical switch in accordance with certain implementations of the disclosed technology.

FIG. 12 is a first back perspective view of the third embodiment of a safety lockout device to be used in connection with an electrical switch in accordance with certain implementations of the disclosed technology.

FIG. 13 is a side elevation view of the third embodiment of a safety lockout device to be used in connection with an electrical switch in accordance with certain implementations of the disclosed technology.

FIG. 14 is a front plan view of the third embodiment of a safety lockout device to be used in connection with an electrical switch in accordance with certain implementations of the disclosed technology.

FIG. 15 is a back plan view of the third embodiment of a safety lockout device to be used in connection with an electrical switch in accordance with certain implementations of the disclosed technology.

FIG. 16 is a top side elevation view of the third embodiment of a safety lockout device to be used in connection with an electrical switch in accordance with certain implementations of the disclosed technology.

FIG. 17 is a bottom side elevation view of the third embodiment of a safety lockout device to be used in connection with an electrical switch in accordance with certain implementations of the disclosed technology.

FIG. 18 is a front perspective view of a fourth embodiment of a safety lockout device for an electrical switch in accordance with certain implementations of the disclosed technology.

FIG. 19 is a second front perspective view of the fourth embodiment of a safety lockout device for an electrical switch in accordance with certain implementations of the disclosed technology.

FIG. 20 is a first back perspective view of the fourth embodiment of a safety lockout device for an electrical switch in accordance with certain implementations of the disclosed technology.

FIG. 21 is a side elevation view of the fourth embodiment of a safety lockout device for an electrical switch in accordance with certain implementations of the disclosed technology.

FIG. 22 is a front plan view of the fourth embodiment of a safety lockout device for an electrical switch in accordance with certain implementations of the disclosed technology.

FIG. 23 is a back plan view of the fourth embodiment of a safety lockout device for an electrical switch in accordance with certain implementations of the disclosed technology.

FIG. 24 is a top side elevation view of the fourth embodiment of a safety lockout device for an electrical switch in accordance with certain implementations of the disclosed technology.

FIG. 25 is a bottom side elevation view of the fourth embodiment of a safety lockout device for an electrical switch in accordance with certain implementations of the disclosed technology.

### DETAILED DESCRIPTION

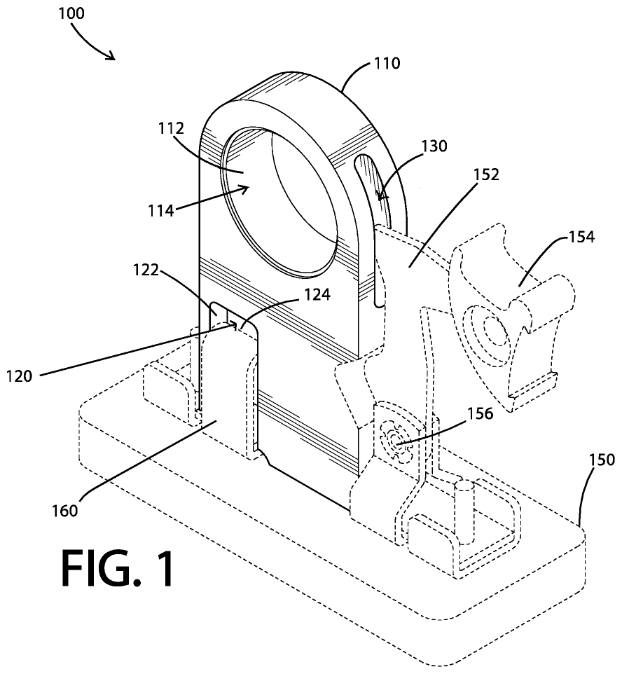

FIG. 1 is a first front perspective view 100 of a first embodiment of a safety lockout device 110 to be used in connection with an electrical switch 150 in accordance with certain implementations of the disclosed technology. In the example, the safety lockout device 110 includes a locking portion 120 that is partially defined by a first inner surface 122 and includes an insertion portion 124 that is configured to be inserted into a receiving portion 160 of the electrical switch 150, e.g., during a lockout/tagout procedure.

In certain embodiments, the receiving portion 160 of the electrical switch 150 may include a “jaw” portion or other suitable mechanism that is configured to receive the arm 152 of the electrical switch 150. In such embodiments, the electrical switch 150 may be a blade switch and the arm 152 may include a “blade.”

In the example, the safety lockout device 110 also includes an opening 114 that is defined by a second inner surface 112. The opening 114 is configured to advantageously allow a user to grab and hold the safety lockout device 110 by inserting at least one finger into the opening 114, for example.

The opening 114 is also configured to advantageously allow a tag or other suitable item to be coupled with the safety lockout device 110. During a lockout/tagout, for example, a user may be required to attach a tag to the safety lockout device 110 in order to establish a visual indication that the electrical switch 150 is locked in an open position such that the electrical connection provided by the electrical switch is not established.

The electrical switch 150 also includes an arm 152 that is configured to rotate about a pivot coupling 156. A handle 154 of the electrical switch is configured to be gripped by a user in order to reposition the arm 152, e.g., to rotate the arm 152 about the pivot coupling 156 to close the electrical switch 150 and thus allow for the electrical connection provided by the electrical switch 150 to be established.

In the example, the safety lockout device 110 also includes a receiving portion 130 configured to receive a portion of the arm 152 of the electrical switch 150. For example, a user may rotate the arm 152 about the pivot coupling 156 and toward the safety lockout device 110 until the arm 152 presses against the safety lockout device 110 in the receiving portion 130 such that the arm 152 is effectively locked in place.

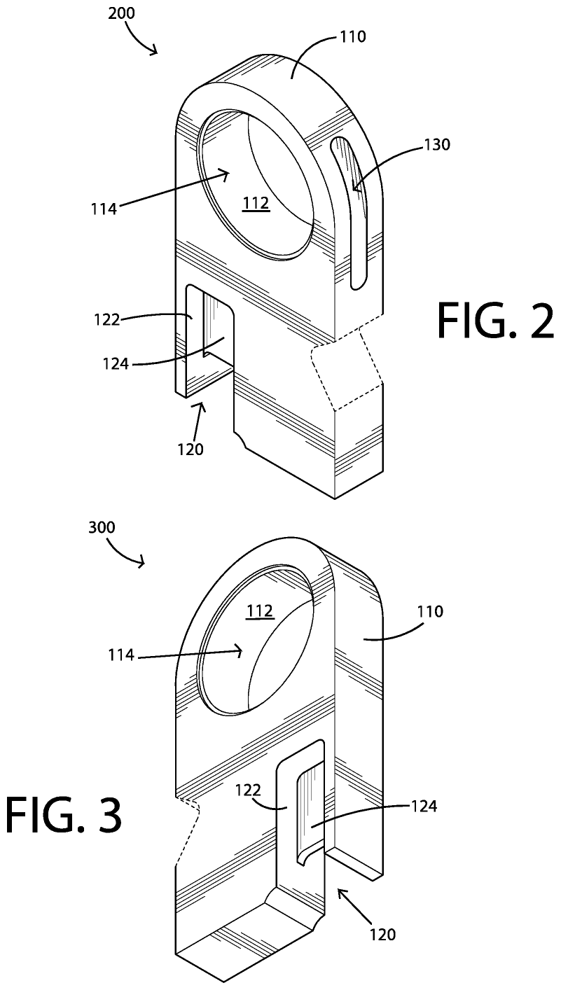

FIG. 2 is a second front perspective view 200 of the first embodiment of a safety lockout device 110 to be used in connection with an electrical switch 150 in accordance with certain implementations of the disclosed technology. In this view 200, the locking portion 120 of the safety lockout device 110 is not engaged with the receiving portion 160 of the electrical switch 150. Also in this view 200, the receiving portion 130 of the safety lockout device 110 is not engaged with the arm 152 of the electrical switch 150.

FIG. 3 is a first back perspective view 300 of the first embodiment of a safety lockout device 110 to be used in connection with an electrical switch 150 in accordance with certain implementations of the disclosed technology. The opening 114 defined by the inner surface 112 and the locking portion 120 of the safety lockout device 110 can each be seen from a different angle in this view 300.

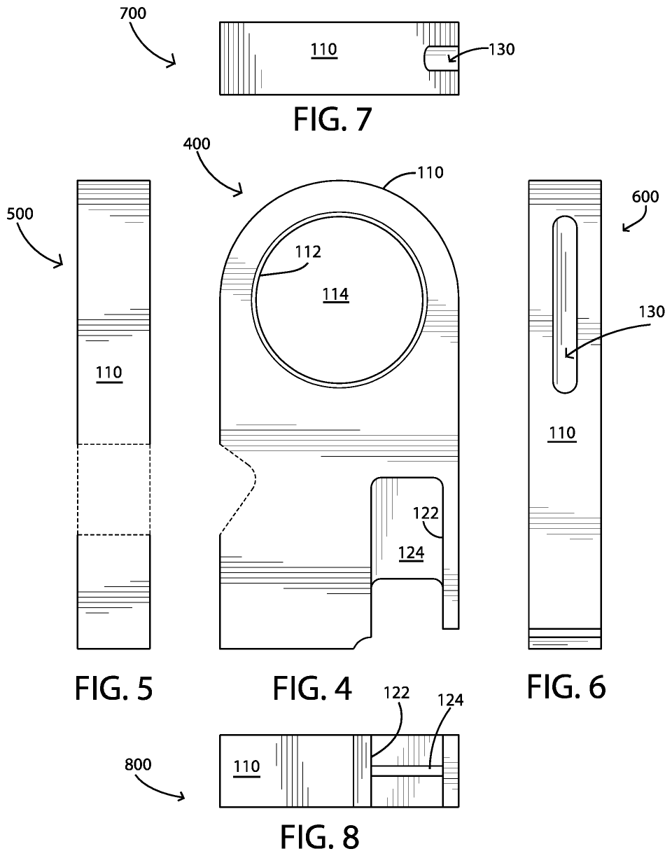

FIG. 4 is a side elevation view 400 of the first embodiment of a safety lockout device 110 to be used in connection with an electrical switch 150 in accordance with certain implementations of the disclosed technology.

FIG. 5 is a front plan view 500 of the first embodiment of a safety lockout device 110 to be used in connection with an electrical switch 150 in accordance with certain implementations of the disclosed technology.

FIG. 6 is a back plan view 600 of the first embodiment of a safety lockout device 110 to be used in connection with an electrical switch 150 in accordance with certain implementations of the disclosed technology. The receiving portion 130 of the safety lockout device 110 can be seen from a different angle in this view 600.

FIG. 7 is a top side elevation view 700 of the first embodiment of a safety lockout device 110 to be used in connection with an electrical switch 150 in accordance with certain implementations of the disclosed technology.

FIG. 8 is a bottom side elevation view 800 of the first embodiment of a safety lockout device 110 to be used in connection with an electrical switch 150 in accordance with certain implementations of the disclosed technology. The locking portion 120 of the safety lockout device 110 can be seen from a different angle in this view 800.

It will be appreciated that the safety lockout device 110 can be made of any suitable non-conductive material, such as linen phenolic, polymer material, urethane, nylon, plastic or rubber, for example. The safety lockout device 110 may be made from a mold, e.g., single construction, or by separate production and subsequent combination of the various portions of the safety lockout device 110.

In certain implementations, the safety lockout device 110 may have a length of 2 1/2 inches, a height of 1 5/16 inches, and a width of 1/2 inch. It will be appreciated that any or all of these dimensions may be altered in other implementations.

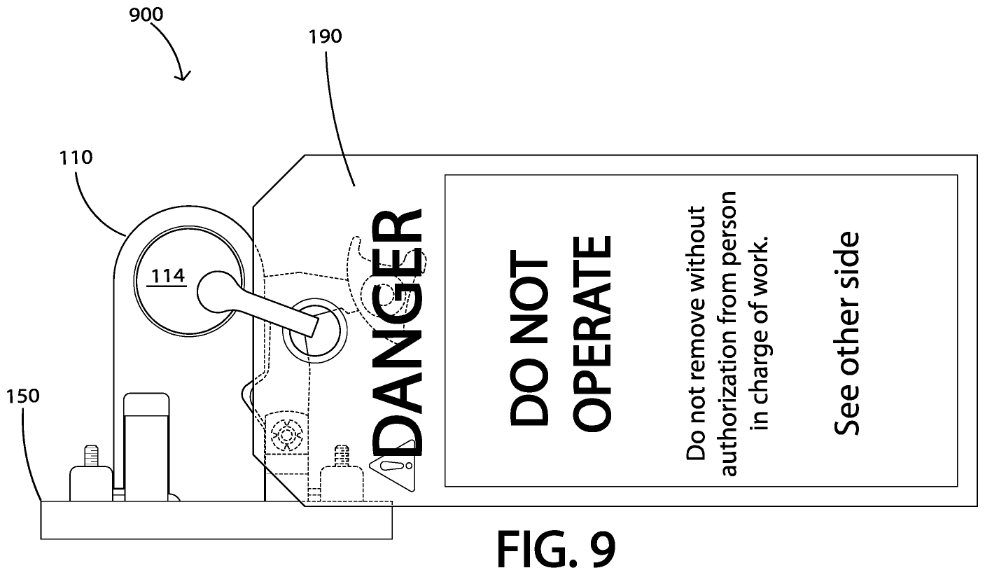

FIG. 9 is a front perspective view 900 of a second embodiment of a safety lockout device 110 to be used in connection with an electrical switch 150 in accordance with certain implementations of the disclosed technology. In the example, a tag 190 is coupled with the safety lockout device 110 by way of the opening 114 of the safety lockout device 110.

The tag 190 may be coupled to the safety lockout device 110 by way of a tie, a string, a cord, or other suitable mechanism configured to tie to, be snapped around, or otherwise be coupled with the safety lockout device 110 by way of insertion through the opening 114 of the safety lockout device 110.

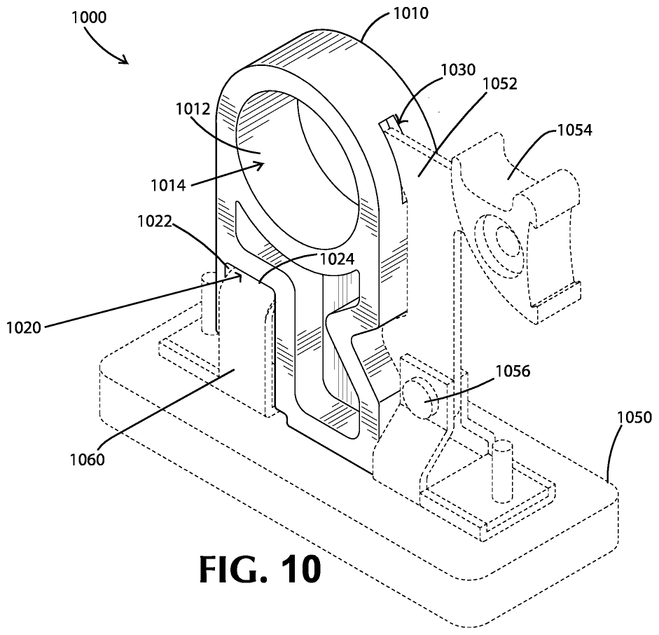

FIG. 10 is a first front perspective view 1000 of a third embodiment of a safety lockout device 1010 to be used in connection with an electrical switch 1050 in accordance with certain implementations of the disclosed technology. In the example, the safety lockout device 1010 includes a locking portion 1020 that is partially defined by a first inner surface 1022 and includes an insertion portion 1024 that is configured to be inserted into a receiving portion 1060 of the electrical switch 1050, e.g., during a lockout/tagout procedure.

In certain embodiments, the receiving portion 1060 of the electrical switch 1050 may include a “jaw” portion or other suitable mechanism that is configured to receive the arm 1052 of the electrical switch 1050. In such embodiments, the electrical switch 1050 may be a blade switch and the arm 1052 may include a “blade.”

In the example, the safety lockout device 1010 also includes an opening 1014 that is defined by a second inner surface 1012. The opening 1014 is configured to advantageously allow a user to grab and hold the safety lockout device 1010 by inserting at least one finger into the opening 1014, for example.

The opening 1014 is also configured to advantageously allow a tag or other suitable item to be coupled with the safety lockout device 1010. During a lockout/tagout, for example, a user may be required to attach a tag to the safety lockout device 1010 in order to establish a visual indication that the electrical switch 1050 is locked in an open position such that the electrical connection provided by the electrical switch is not established.

The electrical switch 1050 also includes an arm 1052 that is configured to rotate about a pivot coupling 1056. A handle 1054 of the electrical switch is configured to be gripped by a user in order to reposition the arm 1052, e.g., to rotate the arm 1052 about the pivot coupling 1056 to close the electrical switch 1050 and thus allow for the electrical connection provided by the electrical switch 1050 to be established.

In the example, the safety lockout device 1010 also includes a receiving portion 1030 configured to receive a portion of the arm 1052 of the electrical switch 1050. For example, a user may rotate the arm 1052 about the pivot coupling 1056 and toward the safety lockout device 1010 until the arm 1052 presses against the safety lockout device 1010 in the receiving portion 1030 such that the arm 1052 is effectively locked in place.

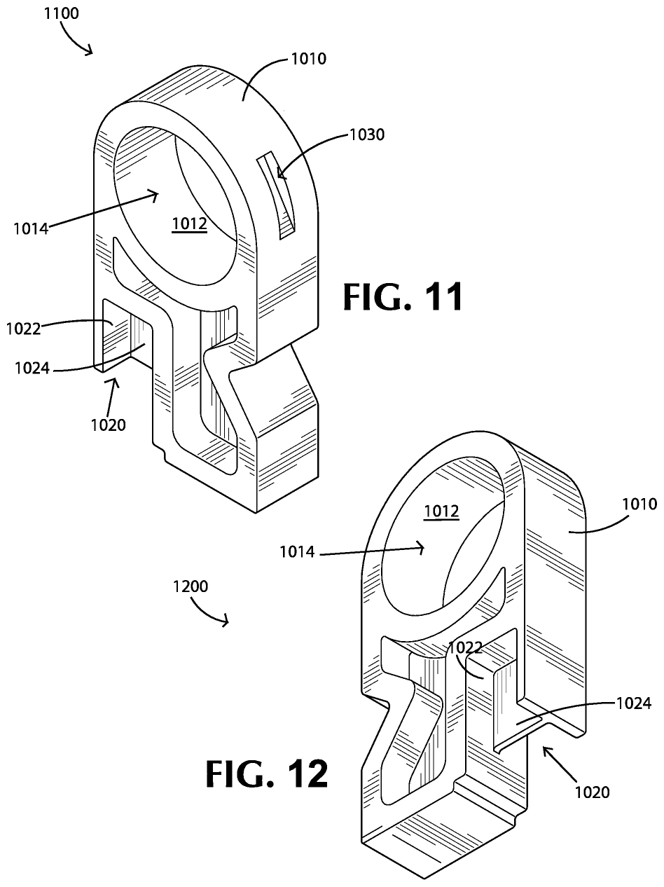

FIG. 11 is a second front perspective view 1100 of the third embodiment of a safety lockout device 1010 to be used in connection with an electrical switch 1050 in accordance with certain implementations of the disclosed technology. In this view 1100, the locking portion 1020 of the safety lockout device 1010 is not engaged with the receiving portion 1060 of the electrical switch 1050. Also in this view 1100, the receiving portion 1030 of the safety lockout device 1010 is not engaged with the arm 1052 of the electrical switch 1050.

FIG. 12 is a first back perspective view 1200 of the third embodiment of a safety lockout device 1010 to be used in connection with an electrical switch 1050 in accordance with certain implementations of the disclosed technology. The opening 1014 defined by the inner surface 1012 and the locking portion 1020 of the safety lockout device 1010 can each be seen from a different angle in this view 1200.

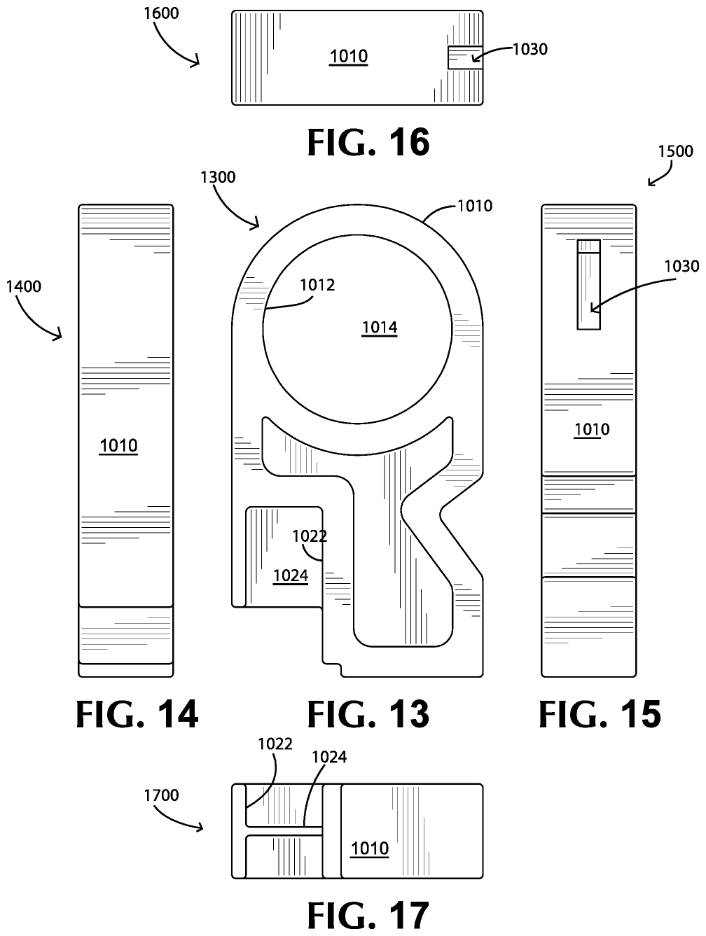

FIG. 13 is a side elevation view 1300 of the third embodiment of a safety lockout device 1010 to be used in connection with an electrical switch 1050 in accordance with certain implementations of the disclosed technology.

FIG. 14 is a front plan view 1400 of the third embodiment of a safety lockout device 1010 to be used in connection with an electrical switch 1050 in accordance with certain implementations of the disclosed technology.

FIG. 15 is a back plan view 1500 of the third embodiment of a safety lockout device 1010 to be used in connection with an electrical switch 1050 in accordance with certain implementations of the disclosed technology. The receiving portion 1030 of the safety lockout device 1010 can be seen from a different angle in this view 1500.

FIG. 16 is a top side elevation view 1600 of the third embodiment of a safety lockout device 1010 to be used in connection with an electrical switch 1050 in accordance with certain implementations of the disclosed technology.

FIG. 17 is a bottom side elevation view 1700 of the third embodiment of a safety lockout device 1010 to be used in connection with an electrical switch 1050 in accordance with certain implementations of the disclosed technology. The locking portion 1020 of the safety lockout device 1010 can be seen from a different angle in this view 1700.

It will be appreciated that the safety lockout device 1010 can be made of any suitable non-conductive material, such as linen phenolic, polymer material, urethane, nylon, plastic or rubber, for example. The safety lockout device 1010 may be made from a mold, e.g., single construction, or by separate production and subsequent combination of the various portions of the safety lockout device 1010.

In certain implementations, the safety lockout device 110 may have a length of 2½ inches, a height of 1 5/16 inches, and a width of ½ inch. It will be appreciated that any or all of these dimensions may be altered in other implementations.

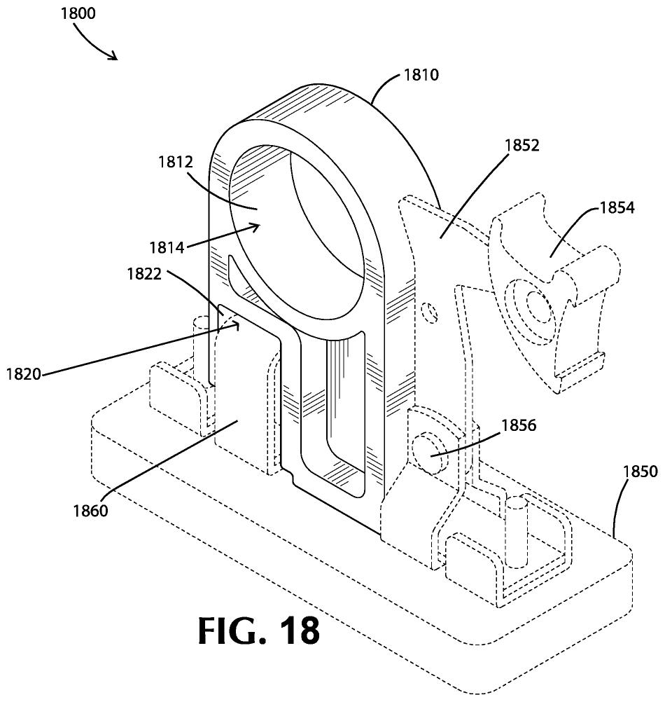

FIG. 18 is a first front perspective view 1800 of a fourth embodiment of a safety lockout device 1810 to be used in connection with an electrical switch 1850 in accordance with certain implementations of the disclosed technology. In the example, the safety lockout device 1810 includes a locking portion 1820 that is partially defined by a first inner surface 1822 and includes an insertion portion 1824 that is configured to be inserted into a receiving portion 1860 of the electrical switch 1850, e.g., during a lockout/tagout procedure.

In certain embodiments, the receiving portion 1860 of the electrical switch 1850 may include a “jaw” portion or other suitable mechanism that is configured to receive the arm 1852 of the electrical switch 1850. In such embodiments, the electrical switch 1850 may be a blade switch and the arm 1852 may include a “blade.”

In the example, the safety lockout device 1810 also includes an opening 1814 that is defined by a second inner surface 1812. The opening 1814 is configured to advantageously allow a user to grab and hold the safety lockout device 1810 by inserting at least one finger into the opening 1814, for example.

The opening 1814 is also configured to advantageously allow a tag or other suitable item to be coupled with the safety lockout device 1810. During a lockout/tagout, for example, a user may be required to attach a tag to the safety lockout device 1810 in order to establish a visual indication that the electrical switch 1850 is locked in an open position such that the electrical connection provided by the electrical switch is not established.

The electrical switch 1850 also includes an arm 1852 that is configured to rotate about a pivot coupling 1856. A handle 1854 of the electrical switch is configured to be gripped by a user in order to reposition the arm 1852, e.g., to rotate the arm 1852 about the pivot coupling 1856 to close the electrical switch 1850 and thus allow for the electrical connection provided by the electrical switch 1850 to be established.

In the example, the safety lockout device 1810 also includes a receiving portion 1830 configured to receive a portion of the arm 1852 of the electrical switch 1850. For example, a user may rotate the arm 1852 about the pivot coupling 1856 and toward the safety lockout device 1810 until the arm 1852 presses against the safety lockout device 1810 in the receiving portion 1830 such that the arm 1852 is effectively locked in place.

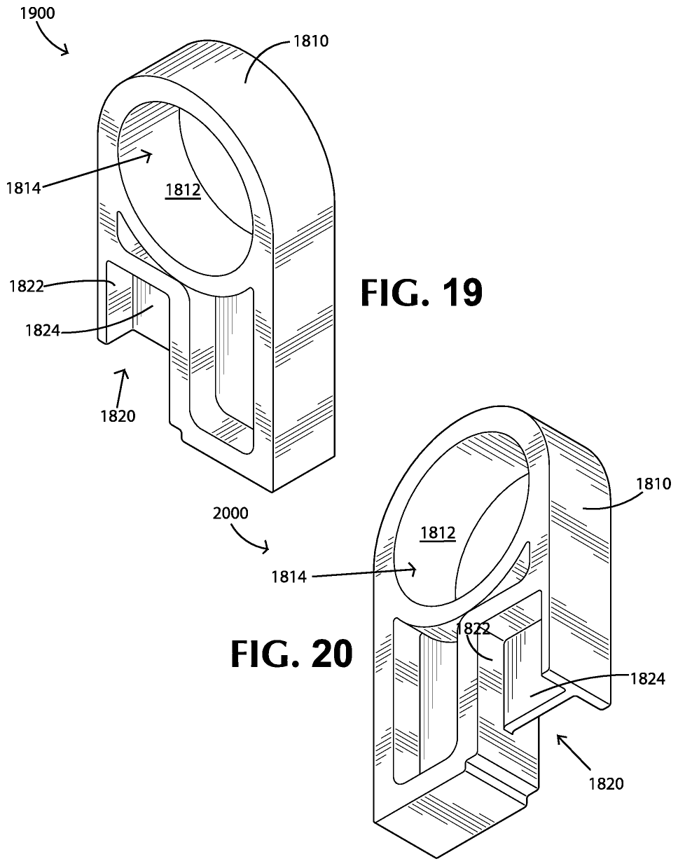

FIG. 19 is a second front perspective view 1900 of the fourth embodiment of a safety lockout device 1810 to be used in connection with an electrical switch 1850 in accordance with certain implementations of the disclosed technology. In this view 1900, the locking portion 1820 of the safety lockout device 1810 is not engaged with the receiving portion 1860 of the electrical switch 1850. Also in this view 1900, the receiving portion 1830 of the safety lockout device 1810 is not engaged with the arm 1852 of the electrical switch 1850.

FIG. 20 is a first back perspective view 2000 of the fourth embodiment of a safety lockout device 1810 to be used in connection with an electrical switch 1850 in accordance with certain implementations of the disclosed technology. The opening 1814 defined by the inner surface 1812 and the locking portion 1820 of the safety lockout device 1810 can each be seen from a different angle in this view 2000.

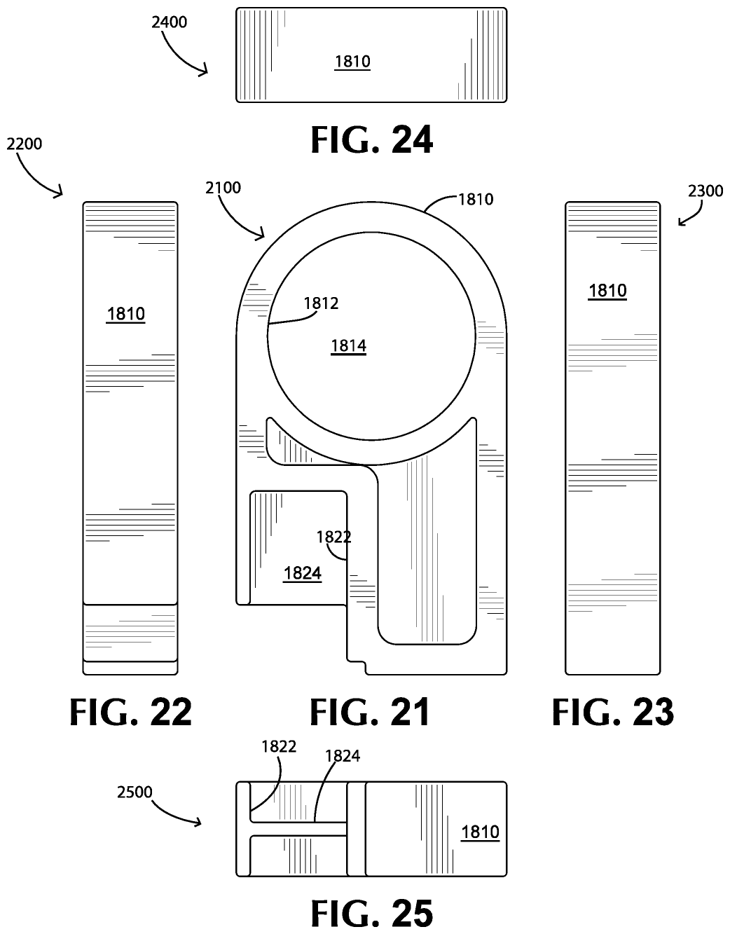

FIG. 21 is a side elevation view 2100 of the fourth embodiment of a safety lockout device 1810 to be used in connection with an electrical switch 1850 in accordance with certain implementations of the disclosed technology.

FIG. 22 is a front plan view 2200 of the fourth embodiment of a safety lockout device 1810 to be used in connection with an electrical switch 1850 in accordance with certain implementations of the disclosed technology.

FIG. 23 is a back plan view 2300 of the fourth embodiment of a safety lockout device 1810 to be used in connection with an electrical switch 1850 in accordance with certain implementations of the disclosed technology. The receiving portion 1830 of the safety lockout device 1810 can be seen from a different angle in this view 2300.

FIG. 24 is a top side elevation view 2400 of the fourth embodiment of a safety lockout device 1810 to be used in connection with an electrical switch 1850 in accordance with certain implementations of the disclosed technology.

FIG. 25 is a bottom side elevation view 2500 of the fourth embodiment of a safety lockout device 1810 to be used in connection with an electrical switch 1850 in accordance with certain implementations of the disclosed technology. The locking portion 1820 of the safety lockout device 1810 can be seen from a different angle in this view 2500.

It will be appreciated that the safety lockout device 1810 can be made of any suitable non-conductive material, such as linen phenolic, polymer material, urethane, nylon, plastic or rubber, for example. The safety lockout device 1810 may be made from a mold, e.g., single construction, or by separate production and subsequent combination of the various portions of the safety lockout device 1810.

In certain implementations, the safety lockout device 1810 may have a length of 2½ inches, a height of 1 7/16 inches, and a width of ½ inch. It will be appreciated that any or all of these dimensions may be altered in other implementations.

It will be appreciated that variants of the above-disclosed and other features and functions, or alternatives thereof, may be combined into many other different systems or applications.

Various presently unforeseen or unanticipated alternatives, modifications, variations, or improvements therein may be subsequently made by those skilled in the art which are also intended to be encompassed by the following claims.

We claim:

1. A safety lockout device, comprising:
a main body;
a receiving portion of the main body configured to receive a portion of an arm of an electrical switch; and
a locking portion of the main body configured to be inserted into a receiving portion of the electrical switch.

2. The safety lockout device of claim 1, further comprising an opening defined by a first inner surface of the main body.

3. The safety lockout device of claim 2, wherein the opening is configured to allow a tag to be coupled to the main body.

4. The safety lockout device of claim 1, wherein the locking portion of the main body is defined by a first inner surface of the main body.

5. The safety lockout device of claim 4, wherein the locking portion of the main body is further defined by an insertion portion of the main body configured to be inserted into a receiving portion of the electrical switch.

6. The safety lockout device of claim 1, wherein the receiving portion of the main body is further configured to substantially maintain a positioning of the portion of the arm of the electrical switch.

7. The safety lockout device of claim 1, wherein the main body is made of a non-conductive material.

8. The safety lockout device of claim 7, wherein the non-conductive material is selected from the group consisting of: linen phenolic, polymer material, urethane, nylon, plastic, and rubber.

9. The safety lockout device of claim 1, wherein the main body has a height of 1 7/16 inches, a length of 2½ inches, and a width of ½ inch.

10. The safety lockout device of claim 1, wherein the main body has a height of 5/16 inches, a length of 2½ inches, and a width of ½ inch.

11. A system, comprising:
at least one electrical switch including:
a base portion;
a receiving portion; and
an arm; and
at least one safety lockout device including:
a main body;
a receiving portion of the main body configured to receive a portion of the arm of a corresponding one of the at least one electrical switch; and
a locking portion of the main body configured to be inserted into a receiving portion of the corresponding one of the at least one electrical switch.

12. The system of claim 11, the at least one safety lockout device further comprising an opening defined by a first inner surface of the main body.

13. The system of claim 12, further comprising a tag coupled to the main body of the at least one safety lockout device by way of the opening.

14. The system of claim 11, wherein the locking portion of the main body of the at least one safety lockout device is defined by a first inner surface of the main body.

15. The system of claim 14, wherein the locking portion of the main body of the at least one safety lockout device is further defined by an insertion portion of the main body of the at least one safety lockout device configured to be inserted into a receiving portion of the electrical switch.

16. The system of claim 11, wherein the receiving portion of the main body of the at least one safety lockout device is further configured to substantially maintain a positioning of the portion of the arm of the electrical switch.

17. The system of claim 11, wherein the main body of the at least one safety lockout device is made of a non-conductive material.

18. The system of claim 17, wherein the non-conductive material is selected from the group consisting of: linen phenolic, polymer material, urethane, nylon, plastic, and rubber.

19. The system of claim 11, wherein the main body of the at least one safety lockout device has a height of 1 7/16 inches, a length of 2½ inches, and a width of ½ inch.

20. The system of claim 11, wherein the main body of the at least one safety lockout device has a height of 1 5/16 inches, a length of 2½ inches, and a width of ½ inch.
